(19) United States
(12) Patent Application Publication
(10) Pub. No.: US 2003/0039275 A1
(43) Pub. Date: Feb. 27, 2003

(54) Method and system for selecting an output of a DBR array

(76) Inventor: Bardia Pezeshki, Redwood City, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/216,115

(22) Filed: Aug. 8, 2002

Related U.S. Application Data
(60) Provisional application No. 60/311,311, filed on Aug. 8, 2001.

(51) Int. Cl. H01S 3/10; H01S 3/08

(52) U.S. Cl. 372/20; 372/96

(57) ABSTRACT

An array of distributed Bragg reflector (DBR) lasers are individually activated to direct light at a MEMS mirror. The MEMS mirror reflects the light to an optical output.

### CROSS-REFERENCE TO RELATED APPLICATIONS

This application claims the benefit of Provisional Patent Application No. 60/311,311, entitled METHOD AND SYSTEM FOR SELECTING AN OUTPUT OF A DBR ARRAY, filed Aug. 8, 2002, the disclosure of which is incorporated by reference.

### BACKGROUND

The present invention relates generally to tunable lasers, and more particularly to a tunable laser including an array of distributed Bragg reflector lasers.

Fiber optic communication links often use lasers for transmitting data over fiber optic lines. Wavelength division multiplex (WDM) communication links are often used so that the transmission band of an optical link is increased by using different light beams at differing wavelengths simultaneously to transmit data. The light beams are generally generated using lasers, with the light beams modulated to carry data.

One type of laser is a distributed Bragg reflector (DBR) laser. DBR lasers, and variations thereof, are discussed, for example, in U.S. Pat. No. 6,141,370 and Murata et al., “Over 720 GHz (5.8 nm) Frequency Tuning by a 1.5 mm DBR Laser with Phase and Bragg Wavelength Control Regions, in Electronics Letters, vol 23 (8) p. 403-405, 1987 (See also Tohmori, et al., Broad-Range Wavelength-Tunable Superstructure Grating (SSG) DBR Lasers, IEEE Journal of Quantum Electronics, vol. 29, No. 6, 1817-1823 (1997)), the disclosures of which are incorporated by reference. DBR lasers generally include at least one active section and at least one tuning section. The tuning section generally includes a Bragg grating, and injection of current into the tuning section allows for tuning, often in the range of 6-10 nm, of the output wavelength. DBR lasers therefore may be electronically tuned, but over a relatively limited range. Though there are other types of DBR lasers, such as sampled grating devices that attempt to expand this tuning range, they do so at the cost of lower optical power, poor reliability, and low optical quality.

WDM communication systems generally operate in ranges greater than 10 nm. For example, WDM system may cover a range of 36 nm, which is generally greater than the tuning range of a simple DBR laser. Thus, a single DBR laser is insufficient to provide for the equipment needs of an installer or maintainer of a WDM system.

### BRIEF SUMMARY OF THE INVENTION

In one embodiment a device in accordance with aspects of the present invention comprises an array of DBR lasers, the DBR lasers having center wavelengths so that the DBR lasers together cover a wide tuning range. A microelectromechanical structure (MEMS) optical element couples light from a selectable one of the DBR lasers into an optical fiber.

In one aspect the invention provides a wavelength tunable laser comprising a distributed Bragg reflector (DBR) array including a first DBR laser that generates a first beam of light in a first wavelength range and a second DBR laser that generates a second beam of light in a second wavelength range; an optical waveguide; and a microelectromechanical system (MEMS) optical element adjustable to selectively couple one of said first and second beams of light from said DBR laser array into the optical waveguide.

In another aspect the invention provides a telecommunications laser package adapted to couple an optical signal having a predetermined wavelength selected from a plurality of predetermined wavelengths into an optical waveguide comprising a plurality of DBR lasers formed in an array, at least two of the DBR lasers generating an optical signal having substantially different wavelengths; and a collimating lens mounted in a microelectromechanical structure (MEMS) moveable to couple light emitted from any one of the DBR lasers along a path calculated to enter the optical waveguide.

In another aspect the invention provides a telecommunications laser package adapted to couple an optical signal having a predetermined wavelength selected from a plurality of predetermined wavelengths into an optical waveguide comprising a plurality of DBR lasers formed in an array, at least two of the DBR lasers generating an optical signal having substantially different wavelengths; and a microelectromechanical structure (MEMS) mirror moveable to reflect light emitted from any one of the DBR lasers along a path calculated to enter the optical waveguide.

In another aspect the invention provides a telecommunication network including a tunable laser system, the tunable laser system providing an optical signal transmitting information over a fiber optic line, the optical signal being of a wavelength selected from a plurality of predetermined wavelengths, the tunable laser comprising an array of distributed Bragg reflector (DBR) lasers, each of the DBR lasers emitting light in a predetermined wavelength range, at least some of the DBR lasers emitting light in different wavelength ranges; and a MEMS mirror moveable so as to couple light from any one of the DBR lasers on a path expected to result in transmission of the light on the fiber optic line.

These and other features of the invention will be more readily appreciated by reference to the following description and accompanying figures.

### BRIEF DESCRIPTION OF THE DRAWINGS

FIG. 1 illustrates one embodiment of an optical arrangement of an array of distributed Bragg reflector (DBR) lasers coupled to an optical output;

FIG. 2 illustrates another embodiment of an array of DBR lasers coupled to an optical output;

FIG. 3 illustrates another embodiment of an array of DBR lasers coupled to an optical output; and

FIG. 4 illustrates another embodiment of an array of DBR lasers coupled to an optical output.

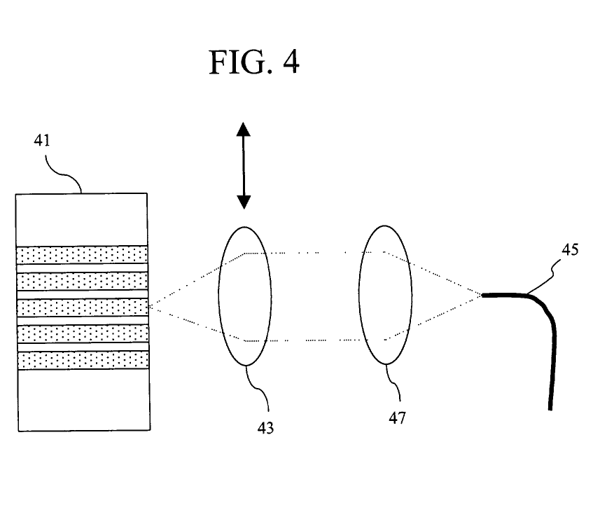

### DETAILED DESCRIPTION

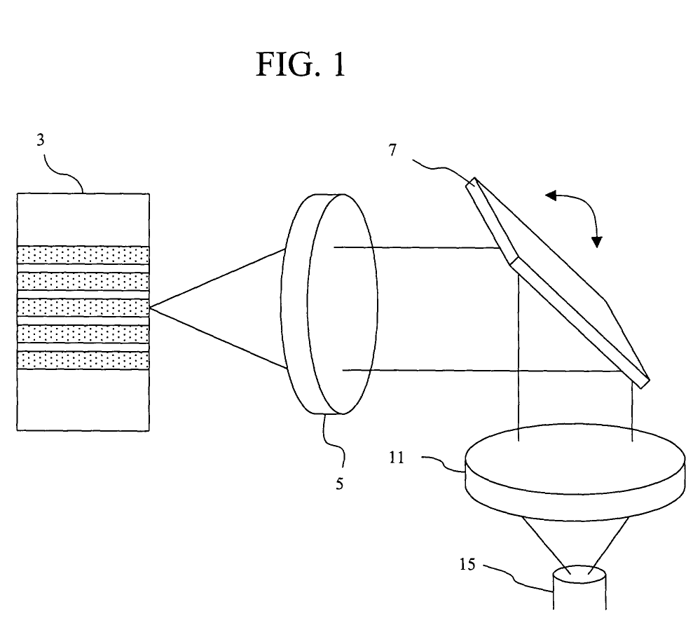

FIG. 1 illustrates an array of DBR lasers 3. The DBR lasers provide light to a coupler. The coupler provides light from a selected laser to an output optical fiber 15. The lasers are independently addressable, each having separate contact pads for injection of current into the laser. Each laser in the array of lasers is designed to operate at differing wavelength ranges.

In one embodiment the coupler is a MEMS optical device. Thus, as illustrated in FIG. 1, the MEMS optical device is a mirror 7. Light from the DBR lasers is passed through a collimating lens 5. In the embodiment of FIG. 1, the collimating lens is placed one focal length away from the DBR array. The collimating lens collimates the light from the DBRs. The light exiting the collimating lens is reflected by the mirror. The mirror is a reflective surface on a MEMS structure, and is therefore a MEMS mirror. The mirror is a moveable mirror.

In some embodiments the mirror is linearly translated. Linearly translatable mirrors may be actuated using a MicroElectroMechanical System (MEMS) actuator. Examples of such actuators include electrostatic comb drives combined with restoring springs, or thermally or electrically actuated devices.

In some embodiments the mirror is a MEMS mirror rotatable about a single axes or about two axis. Manufacture of MEMS mirrors is relatively well known, and the mirrors may be fabricated using, for example, bulk micromachining with silicon wafers or silicon on insulator (SOI) wafers. The structure may formed by etching surfaces of the wafer with one or more masking steps, and multiple structures may be bonded together, for example using anodic bonding, to form a resultant structure. A metalization step may provide device contacts and also be used to form a highly reflective layer as the mirror surface. Backside etching and/or further etching steps on the front surface may also be useful to release strain or to create various device characteristics.

In one embodiment, the MEMS mirror is can rotate on two axes, such as the MEMS mirror described in Provisional Patent Application No. 60/309,669, entitled MEMS Mirror, filed Aug. 2, 2001, the disclosure of which is incorporated by reference herein. In one embodiment the MEMS mirror is electronically actuated by plane voltages to contact pads on the MEMS structure. In other embodiments, current is passed through comb structures or flex springs to adjust the position of the mirror.

In one embodiment, and as illustrated in FIG. 1, the MEMS mirror is placed one focal length away from the collimating lens. Adjusting the tilt of the mirror causes reflection of light from each laser in the array of lasers along the same path as the light from each of the DBRs impinges the mirror at substantially the same position but different angles. Light reflected from the mirror, in the embodiment illustrated in FIG. 1, is directed to a focusing lens 11. The focusing lens couples light to an optical waveguide, formed in the embodiment of FIG. 1 by an optic fiber. In alternative embodiments, elements such as optical isolators and/or other elements may be placed in front of the optical fiber, or other waveguides such as those formed in lithium niobate may be used.

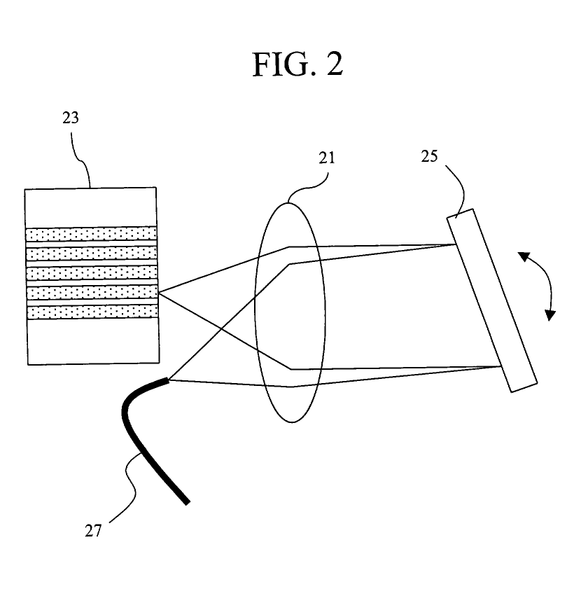

A further embodiment is illustrated in FIG. 2. FIG. 2 includes an array of DBR lasers 23. The optical beam from a selected laser of the array, which may be any laser in the array, is collimated with a fixed lens 24. A moveable MEMS mirror 25 receives the collimated light and reflects the collimated light back to the lens. Accordingly, the MEMS mirror is close to normal incidence, and substantially perpendicular to the beam. The lens receives the reflected light and focuses the light onto an output fiber 27.

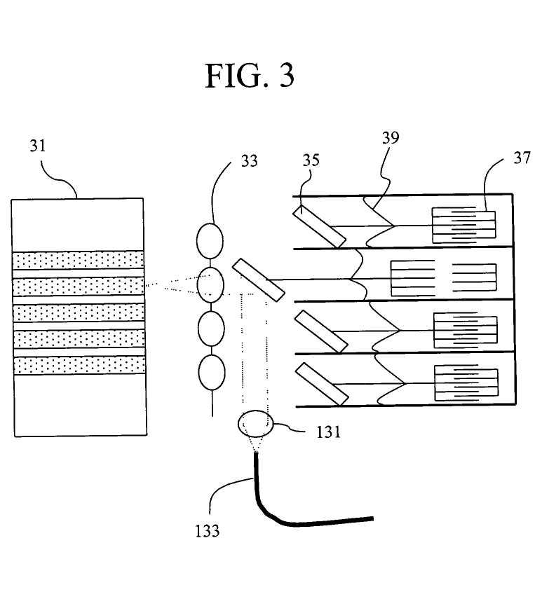

A further embodiment is illustrated in FIG. 3. As illustrated in FIG. 3, the output of an array of DBR lasers 31 is each provided to a collimating lens 33. As illustrated, each laser has its own collimating lens. The collimating lens passes the light emitted from the lasers to a series of micro mirrors 35. The micro mirrors are extended and retracted by a combination of a electrostatic comb actuator 37 and a spring 39. Extension of a particular mirror reflects light passed through a particular collimating lens to a focusing lens 131. The focusing lens focuses the light on the end of an output fiber 133.

In the above embodiments, gross selection of a wavelength range is accomplished by selecting a DBR laser out of plurality DBR lasers formed on the same substrate. Fine selection of the wavelength is accomplished by controlling charge injection into the DBR laser of interest.

Although the present invention has been described with respect to certain embodiments, those of skill in the art would recognize insubstantially different variations thereof. Accordingly, the present invention should be viewed as the claims supported by this disclosure and insubstantial variations thereof.

What is claimed is:

1. A wavelength tunable laser comprising:
a distributed Bragg reflector (DBR) array including a first DBR laser that generates a first beam of light in a first wavelength range and a second DBR laser that generates a second beam of light in a second wavelength range;
an optical waveguide; and
a microelectromechanical system (MEMS) optical element adjustable to selectively couple one of said first and second beams of light from said DBR laser array into the optical waveguide.

2. The wavelength tunable laser of claim 1 wherein said MEMS optical element includes:
a collimating lens; and
a MEMS actuator that adjusts a position of the collimating lens to select the one of the first and second beams of light.

3. The wavelength tunable laser of claim 2 wherein the MEMS actuator moves in one plane.

4. The wavelength tunable laser of claim 2 wherein the MEMS actuator includes an electrostatic actuator.

5. The wavelength tunable laser of claim 2 wherein the MEMS actuator includes a thermal actuator.

6. The wavelength tunable laser of claim 2 further comprising a focusing lens that is optically positioned between the collimating lens and the optical waveguide.

7. The wavelength tunable laser of claim 1 wherein the optical waveguide includes an optical fiber.

8. The wavelength tunable laser of claim 1 further comprising a third DBR laser that generates a third beam of light in a third wavelength range, with the third wavelength range overlapping at least one of the first and second wavelength ranges.

9. The wavelength tunable laser of claim 1 wherein the MEMS optical element comprises:
a mirror; and
a MEMS actuator for tilting the mirror to select the one of said first and second beams of light.

10. The wavelength tunable laser of claim 9 wherein the MEMS actuator includes electrostatic actuators for tilting the movable mirror.

11. The wavelength tunable laser of claim 9 further comprising:
a collimating lens that collimates the first and second beams of light; and
a focusing lens that focuses the one of the first and second beams of light reflected by the mirror into the optical waveguide.

12. The wavelength tunable laser of claim 10 wherein gross selection of wavelength is accomplished by selecting one of the first and second beams of light and fine selection of wavelength is accomplished by controlling charge injection into the DBR laser providing the selected beam of light.

13. A telecommunications laser package adapted to couple an optical signal having a predetermined wavelength selected from a plurality of predetermined wavelengths into an optical waveguide comprising:
a plurality of DBR lasers formed in an array, at least two of the DBR lasers generating an optical signal having substantially different wavelengths; and
a collimating lens mounted in a microelectromechanical structure (MEMS) moveable to couple light emitted from any one of the DBR lasers along a path calculated to enter the optical waveguide.

14. A telecommunications laser package adapted to couple an optical signal having a predetermined wavelength selected from a plurality of predetermined wavelengths into an optical waveguide comprising:
a plurality of DBR lasers formed in an array, at least two of the DBR lasers generating an optical signal having substantially different wavelengths; and
a microelectromechanical structure (MEMS) mirror moveable to reflect light emitted from any one of the DBR lasers along a path calculated to enter the optical waveguide.

15. The telecommunications package of claim 20 wherein the MEMS mirror reflects light emitted from only one of the DBR lasers along a path calculated to enter the optical waveguide.

16. The telecommunications package of claim 21 wherein the optical waveguide is an optical fiber.

17. A telecommunication network including a tunable laser system, the tunable laser system providing an optical signal transmitting information over a fiber optic line, the optical signal being of a wavelength selected from a plurality of predetermined wavelengths, the tunable laser comprising:
an array of distributed Bragg reflector (DBR) lasers, each of the DBR lasers emitting light in a predetermined wavelength range, at least some of the DBR lasers emitting light in different wavelength ranges; and
a MEMS mirror moveable so as to couple light from any one of the DBR lasers on a path expected to result in transmission of the light on the fiber optic line.
